(19) United States
(12) Patent Application Publication
(10) Pub. No.: US 2022/0090905 A1
(43) Pub. Date: Mar. 24, 2022

(54) COORDINATION OF MULTIPLE STRAIN SENSORS

(71) Applicant: Sentons Inc., Grand Cayman (KY)

(72) Inventor: Samuel W. Sheng, Saratoga, CA (US)

(21) Appl. No.: 17/030,236

(22) Filed: Sep. 23, 2020

(51) Int. Cl. G01B 7/16; G01L 9/00; G01L 1/22

(52) U.S. Cl. CPC G01B 7/18; G01L 1/2262; G01L 9/0052

(57) ABSTRACT

A system including strain sensors, transmission lines, and a common receive line is described. The strain sensors receive can receive signal(s) on the transmission lines. The information from the strain sensors is provided on the common receive line. The strain sensors are configured to be selectively activated to transmit information on the common receive line in response to a control signal.

### BACKGROUND OF THE INVENTION

Various electrical components can be used to detect a physical disturbance (e.g., strain, force, pressure, vibration, etc.) and provide a corresponding signal. For example, a component may detect expansion of or pressure on a particular region of a device and provide an output signal in response. Such components may be utilized in devices to detect a touch. For example, a component mounted on a portion of the mobile phone may detect an expansion or flexing of the portion to which the component is mounted and provide an output signal. However, flexing of the mobile phone may be due to a non-purposeful touch. Detecting a touch input based upon such flexing may be undesirable. Consequently, an improved mechanism for accurately distinguishing physical disturbances that may be used in detecting touch input is desired.

### BRIEF DESCRIPTION OF THE DRAWINGS

Various embodiments of the invention are disclosed in the following detailed description and the accompanying drawings.

FIG. 1 is a schematic diagram illustrating an embodiment of a piezoresistive bridge structure usable as a strain sensor.

FIGS. 2A-2B depict embodiment of integrated sensors.

FIG. 3 is a block diagram illustrating an embodiment of a system for detecting a touch inputs utilizing coordinated strain sensors.

FIG. 4 is a diagram depicting an embodiment of a device utilizing force and touch sensors for performing touch input detection.

FIG. 5 is a diagram depicting an embodiment of a device utilizing force and touch sensors for performing touch input detection.

FIG. 6 is a diagram depicting an embodiment of a device utilizing force and touch sensors for performing touch input detection.

FIG. 7 is a flow chart depicting an embodiment of a method for sensing force utilizing integrated sensors.

FIG. 8 is a flow chart depicting an embodiment of a method for sensing force utilizing integrated sensors.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Various electrical components can be used to detect a physical disturbance (e.g., strain, force, pressure, vibration, etc.) and provide a corresponding signal. Such components may be utilized in devices to detect a touch. For example, a component mounted on a portion of the mobile phone may detect an expansion or flexing of the portion to which the component is mounted and provide an output signal. In order to distinguish between a user's intentional touch and other physical disturbances (e.g. bending of the mobile phone), a sufficient amount of data regarding physical disturbances is desired to be acquired. Further, devices such as mobile phones may be small and the region which is being touched by a user smaller. Small changes in position of the user's finger are desired to be distinguishable using such components. For example, a user touching a volume increase button is desired to be distinguished from the user pressing an adjacent volume decrease button. Consequently, components which acquire physical disturbance data are desired to not only be accurate and provide sufficient information, but also be relatively small.

A system that senses physical disturbances and may be compact is described. In some embodiments, such a system includes strain sensors, transmission lines, and a common receive line. The strain sensors may reside on a single integrated circuit. The strain sensors receive can receive signal(s) on the transmission lines. The information from the strain sensors is provided on the common receive line. In some embodiments, multiple receive lines are used. The strain sensors are configured to be selectively activated to transmit information on the common receive line in response to a control signal. The information may include temperature information and/or strain information.

In some embodiments, the system further includes addressing circuitry for selectively activating each of the strain sensors in response to the control signal. For example, in some embodiments, the combination of transmission line(s) and receive line(s) connected to each strain sensor is unique and can be used to address the strain sensors. The control signal uniquely identifies the combination of transmission line(s) and receive line(s) for each strain sensor. Based on the control signal, the addressing circuitry connects the identified transmission line(s) and receive line(s) for a particular strain sensor. Thus, the strain sensor may receive signals via the transmission line(s) and provide data via the receive line(s). In some embodiments, the strain sensors and the addressing circuitry reside on a single integrated circuit. In some such embodiments, pads on the integrated circuit are used to make electrical contact to the integrated circuit. The number of pads may be insufficient for simultaneously operating the multiple strain sensors on the integrated circuit. For example, a small number of pads (e.g. six) may be used in obtaining strain and temperature measurements from a larger number strain sensors (e.g. ten) on an integrated circuit.

In some embodiments, strain sensors are formed on a silicon substrate having a (110) orientation. A first portion of the strain sensors may have a first orientation and a second portion of the plurality of strain sensors may have a second orientation at a nonzero acute angle from the first orientation. For example, in some embodiments, the strain sensors can detect strains in a first direction (e.g. in an x-direction), in a second direction perpendicular to the first direction (e.g. in a y-direction) and at a forty-five degree angle from the first and second directions (e.g. in an xy-direction). In some embodiments, the system includes at least one temperature sensor corresponding to the strain sensors.

In some embodiments, a method described. The method includes receiving the control signal at the integrated circuit. The control signal can be used to selectively activate the strain sensors to provide information on the receive lines. Thus, the method also includes serially providing the information from the strain sensors on the receive lines. In some embodiments, the control signal is a digital control signal indicating particular transmission line(s) and particular receive line(s) corresponding to the desired strain sensor. In some embodiments, the method includes connecting a strain sensor corresponding to the transmit line and the receive line in response to the digital control signal and providing digital information from the strain sensor. In some embodiments, the digital information includes temperature data. The method may further include receiving a digital reset after the providing digital information. The system may then operate in an analog mode. Thus, the strain sensor may receive an encoded analog signal corresponding to the information. The strain sensor provides the information based on the encoded analog signal. The method may further include repeating the connecting, digital information providing, digital reset receiving, encoded analog signal receiving and information providing for each remaining strain sensor of the strain sensors. Thus, information such as temperature, strain and/or force may be received from strain sensors configured in a compact form factor.

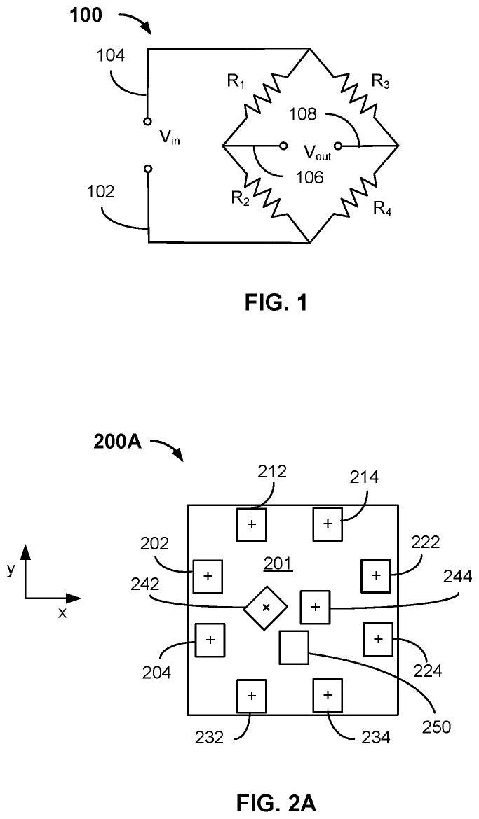

FIG. 1 is a schematic diagram illustrating an embodiment of a piezoresistive bridge structure that can be utilized as a strain sensor. Piezoresistive bridge structure 100 includes four piezoresistive elements that are connected together as two parallel paths of two piezoresistive elements in series (e.g., Wheatstone Bridge configuration). Each parallel path acts as a separate voltage divider. The same supply voltage (e.g., Vᵢₙ of FIG. 1) is applied to both of the parallel paths. By measuring a voltage difference (e.g., Vₒᵤₜ of FIG. 1) between a mid-point at one of the parallel paths (e.g., between piezoresistive elements R₁ and R₂ in series as shown in FIG. 1) and a mid-point of the other parallel path (e.g., between piezoresistive elements R₃ and R₄ in series as shown in FIG. 1), a magnitude of a physical disturbance (e.g. strain) applied on the piezoresistive structure can be detected. Also shown are transmission lines 102 and 104 for providing signals to the piezoeresistive elements and receive lines 106 and 108 for receiving signals from the piezoresistive elements.

In some embodiments, rather than individually attaching separate already manufactured piezoresistive elements together on to a backing material to produce the piezoresistive bridge structure, the piezoresistive bridge structure is manufactured together as a single integrated circuit component and included in an application-specific integrated circuit (ASIC) chip. For example, the four piezoresistive elements and appropriate connections between are fabricated on the same silicon wafer/substrate using a photolithography microfabrication process. In an alternative embodiment, the piezoresistive bridge structure is built using a microelectromechanical systems (MEMS) process. The piezoresistive elements may be any mobility sensitive/dependent element (e.g., as a resistor, a transistor, etc.).

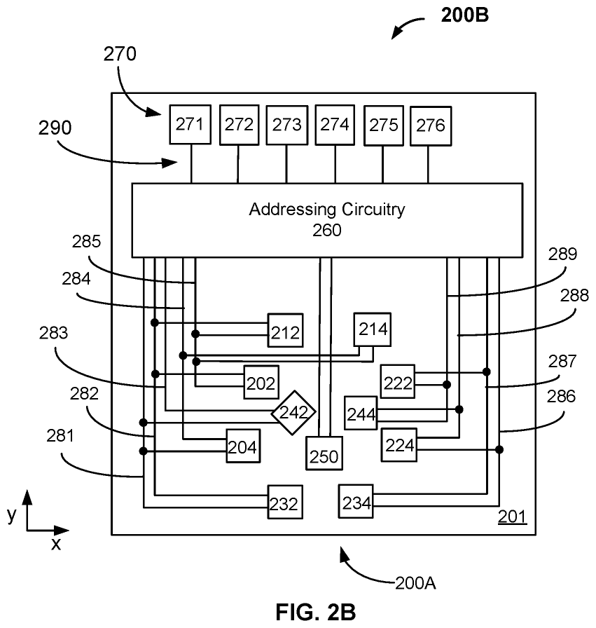

FIGS. 2A-2B are diagrams depicting embodiments of integrated sensors. FIG. 2A depicts an embodiment of integrated sensor 200A that can be used to sense forces (i.e. a force sensor). In particular, forces input to a device may result in flexing of, expansion of, or other physical disturbance in the device. Such physical disturbances may be sensed by force sensors. Integrated sensor 200A includes multiple strain sensors 202, 204, 212, 214, 222, 224, 232, 234, 242 and 244. For simplicity, electrical connection to strain sensors 202, 204, 212, 214, 222, 224, 232, 234, 242 and 244 is not shown in FIG. 2A. Two transmission lines and two receive lines may be connected to each strain sensor 202, 204, 212, 214, 222, 224, 232, 234, 242 and 244. Each strain sensor 202, 204, 212, 214, 222, 224, 232, 234, 242 and 244 may be a piezoresistive element such as piezoresistive element 100. In other embodiments, another strain measurement device might be used. Strain sensors 202, 204, 212, 214, 222, 224, 232, 234, 242 and 244 may be fabricated on the same substrate 201. For example, substrate 201 may be a silicon substrate. In some embodiments, the silicon substrate 201 has a (110) orientation. Multiple integrated sensors 200A may also be fabricated on the same substrate 201 and then singulated for use. Integrated sensor 200A may be small, for example five millimeters by five millimeters (in the x and y directions) or less.

Each strain sensor 202, 204, 212, 214, 222, 224, 232, 234, 242 and 244 is labeled with a + sign indicating the directions of strain sensed. Thus, strain sensors 202, 204, 212, 214, 222, 224, 232, 234 and 244 sense strains (expansion or contraction) in the x and y directions. However, strain sensors at the edges of integrated sensor 200A may be considered to sense strains in a single direction. This is because there is no expansion or contraction beyond the edge of integrated sensor 200A. Thus, strain sensors 202 and 204 and strain sensors 222 and 224 measure strains parallel to the y-axis, while strain sensors 212 and 214 and strain sensors 232 and 234 sense strains parallel to the x-axis. As can be seen in FIG. 2A, strain sensor 242 has been configured in a different direction. Thus, strain sensor 242 measures strains in the xy direction (parallel to the lines x=y or x=−y). Strain sensor 242 may be used to sense twists of integrated sensor 200A. In some embodiments, the output of strain sensor 242 is small or negligible in the absence of a twist to integrated sensor 200A or the surface to which integrated sensor 200A is mounted.

Thus, integrated sensor 200A obtains ten measurements of strain: four measurements of strain in the y direction from strain sensors 202, 204, 222 and 224; four measurements of strain in the x direction from sensors 212, 214, 232 and 234; one measurement of strains in the xy direction from sensors 242 and one measurement of strain from sensor 244. Although ten strain measurements are received from strain sensors 202, 204, 212, 214, 222, 224, 232, 234, 242 and 244, six measurements may be considered independent. Strain sensors 202, 204, 212, 214, 222, 224, 232, and 234 on the edges may be considered to provide four independent measurements of strain. In other embodiments, a different number of strain sensors and/or different locations for strain sensors may be used in integrated sensor 200A. Further, it has been determined that use of a (110) silicon in fabricating strain sensors 202, 204, 212, 214, 222, 224, 232, 234, 242 and 244 may result in increased sensitivity of strain sensors 202, 204, 212, 214, 222, 224, 232, 234, 242 and 244. Thus, more accurate strain and, therefore, force information may be received from integrated sensor 200A.

Integrated sensor 200A also includes temperature sensor 250 in some embodiments. Temperature sensor 250 provide an onboard measurement of the temperatures to which strain sensors 202, 204, 212, 214, 222, 224, 232, 234, 242 and 244 are exposed. Thus, temperature sensor 250 may be used to account for drift and other temperature artifacts that may be present in strain data. Although a single temperature sensor 250 is shown for integrated sensor 200A, in some embodiments, multiple temperature sensors are present. For example, each strain sensor 202, 204, 212, 214, 222, 224, 232, 234, 242 and 244 may have a corresponding temperature sensor. Thus, the accuracy of measurements from strain sensors 202, 204, 212, 214, 222, 224, 232, 234, 242 and 244 may be enhanced. Integrated sensor 200A may be used in a device for detecting touch inputs.

FIG. 2B depicts integrated sensor 200B. Integrated sensor 200B includes integrated sensor 200A, addressing circuitry 260 and pads 271, 272, 273, 274, 275 and 276 (collectively pads 270). Integrated sensor 200B thus includes strain sensors 202, 204, 212, 214, 222, 224, 232, 234, 242 and 244 analogous to those described in FIG. 2A. Thus, strain sensors 202, 204, 212, 214, 222, 224, 232, 234, and 244 may be used to sense strains in the x and y directions. Strain sensor 242 is oriented at a nonzero acute angle (e.g. forty-five degrees) from the remaining sensors. Strain sensor 242 senses strains in the xy-direction. Integrated sensor 200B may also include temperature sensor 250 analogous to temperature sensor 250 depicted in FIG. 2A. Temperature sensor 250 provide an onboard measurement of the temperatures to which strain sensors 202, 204, 212, 214, 222, 224, 232, 234, 242 and 244 are exposed. Thus, temperature sensor 250 may be used to account for drift and other temperature artifacts that may be present in strain data. In some embodiments, each strain sensor 202, 204, 212, 214, 222, 224, 232, 234, 242 and 244 has a corresponding temperature sensor analogous to temperature sensor 250. In some embodiments, addressing circuitry 260, pads 270 and strain sensors 202, 204, 212, 214, 222, 224, 232, 234, 242 and 244 are fabricated on a single silicon substrate. For example, a substrate having a (110) orientation may be used.

Strain sensors 202, 204, 212, 214, 222, 224, 232, 234, 242 and 244 are formed on substrate 201. In some embodiments, the silicon substrate has a (110) orientation. Multiple integrated sensors 200B may also be fabricated on the same substrate and then singulated for use. Integrated sensor 200B may be small, for example five millimeters by five millimeters (in the x and y directions) or less. Although ten strain sensors 202, 204, 212, 214, 222, 224, 232, 234, 242 and 244 are shown, another number of strain sensors and/or a different configuration of strain sensors may be used. Similarly, although one temperature sensor 250 is shown, another number of temperature sensors and/or a different configuration/location of temperature sensors may be used.

Integrated sensors 200A and 200B also include transmission lines 282, 283, 284, 287 and 288 and receive lines 281, 285, 286 and 289 (collectively lines 280) for strain sensors 202, 204, 212, 214, 222, 224, 232, 234, 242 and 244. Strain sensors 202, 204, 212, 214, 222, 224, 232, 234, 242 and 244 receive signals via transmission lines 282, 283, 284, 287 and 288 (i.e. signals are transmitted to strain sensors via transmission lines). Similarly, strain sensors 202, 204, 212, 214, 222, 224, 232, 234, 242 and 244 provide information via receive lines 281, 285, 286 and 289 (i.e. signals are received from strain sensors via receive lines). In some embodiments, each transmission line and each receive line is a pair of lines. Thus, each strain sensor 202, 204, 212, 214, 222, 224, 232, 234, 242 and 244 may have a configuration shown in FIG. 1. However, transmission and receive lines 281, 282, 283, 284, 285 and 286 are shown as single lines in FIG. 2B for clarity.

In the embodiment shown, receive lines 281, 285, 286 and 289 are common receive lines. For example, strain sensors 232, 204 and 242 share common receive line 281. Thus, multiple strain sensors share receive lines 281, 285, 286 and 289. Transmission lines 282, 284, 287 and 288 are also common transmission lines. For example, sensors 232, 202 and 212 share common transmission line 282. Thus, multiple strain sensors share transmission lines 282, 284, 287 and 288. Transmission line 283 is indicated as being utilized by a single strain sensor 242. In other embodiments, other configurations and/or other numbers of transmission lines and/or receive lines are possible. For example, all strain sensors 202, 204, 212, 214, 222, 224, 232, 234, 242 and 244 may share a single, common receive line. In such embodiments, each strain sensor 202, 204, 212, 214, 222, 224, 232, 234, 242 and 244 may have a separate transmission line. As another example, all strain sensors 202, 204, 212, 214, 222, 224, 232, 234, 242 and 244 may share a single, common transmission line. In such embodiments, each strain sensor 202, 204, 212, 214, 222, 224, 232, 234, 242 and 244 may have a separate receive line. As discussed above, lines 281, 282, 283, 284, 285, 286, 287, 288 and 289 may be considered to represent pairs of lines. In some embodiments, strain sensors 202, 204, 212, 214, 222, 224, 232, 234, 242 and 244 may be connected to lines in different line pairs. For example, strain sensor 204 might be connected to one line in a pair corresponding to transmission line 282 and another line in a pair corresponding to transmission line 284. Thus, a variety of configurations of lines 280 are possible.

Although lines 280 may be configured in a variety of manners, each strain sensor 202, 204, 212, 214, 222, 224, 232, 234, 242 and 244 is connected to a unique combination of transmission and receive lines. Stated differently, strain sensors 202, 204, 212, 214, 222, 224, 232, 234, 242 and 244 may be addressed using the identities of the transmission and receive lines to which they are connected. For example, in the embodiment shown in FIG. 2B, strain sensor 232 is connected to transmission line 283 and receive line 281. Although strain sensors 204 and 242 also share receive line 281, strain sensor 204 is connected to transmission line 284, while strain sensor 242 is connected to transmission line 283. Similarly, strain sensor 214 shares transmission line 284 with strain sensor 204 but has a different receive line 285. Strain sensor 202 shares receive line 285 with strain sensor 214, but is connected to a different transmission line 282. Thus, each strain sensor 202, 204, 212, 214, 222, 224, 232, 234, 242 and 244 is uniquely identifiable by the combination of transmission and receive lines to which it is connected. Each strain sensor 202, 204, 212, 214, 222, 224, 232, 234, 242 and 244 is, therefore, separately addressable based on the transmission and receive lines. As indicated above, lines 281 through 289 may be line pairs. Thus, in some embodiments, strain sensors 202, 204, 212, 214, 222, 224, 232, 234, 242 and/or 244 may be individually addressed based on individual lines in each pair.

Pads 270 may be used to make electrical connection to the components of integrated sensor 200B. In some embodiments, some portion of pads 270 are designated for particular use. For example, pads 271 and 272 may be designated for transmission lines (receiving signals transmitted to integrated sensor 200B), while pads 273 and 274 may be designated for receive lines (outputting information from integrated sensor 200B). In some embodiments, six pads 270 are utilized. However, another number may be present. In some embodiments, the number of pads 270 is less than the number required to individually connect to each strain sensor in the absence of addressing circuitry 260. For example, for ten strain sensors 202, 204, 212, 214, 222, 224, 232, 234, 242 and 244, over twenty pads would be utilized to connect each strain sensor 202, 204, 212, 214, 222, 224, 232, 234, 242 and 244 to a unique set of pads. Because pads 270 are connected to sensors 202, 204, 212, 214, 222, 224, 232, 234, 242 and 244 through addressing circuitry 260, fewer pads 270 may be used. Thus, integrated sensor 200B may be more compact.

Addressing circuitry 260 is coupled to pads 270 and to strain sensors 202, 204, 212, 214, 222, 224, 232, 234, 242 and/or 244 through lines 281 through 289. Addressing circuitry 260 selects (i.e. addresses) individual strain sensors 202, 204, 212, 214, 222, 224, 232, 234, 242 and 244. Stated differently, addressing circuitry 260 selectively connects individual strain sensors 202, 204, 212, 213, 222, 224, 232, 234, 242 and 244 to particular pads 270. Addressing circuitry 260 does so by connecting the unique combination of transmission and receive lines for a selected strain sensor to the desired pads. Consequently, strain sensors 202, 204, 212, 214, 222, 224, 232, 234, 242 244 can be selectively activated to receive signals provided to integrated sensor 200B via the corresponding transmission lines 282, 283, 284, 287 and 288 and to output information from integrated circuit 200B via receive lines 281, 285, 286, and 289. For example, strain sensor 232 may be individually selected to receive signals via transmission line 283 and to transmit information (e.g. strain data) via receive line 281. Similarly, strain sensors 204 may be selected to provide information via receive line 281 and to receive signals via transmission line 284. Thus, each strain sensor 202, 204, 212, 214, 222, 224, 232, 234, 242 and 244 may be separately selected to send and/or receive information. In embodiments in which each strain sensor 202, 204, 212, 214, 222, 224, 232, 234, 242 and 244 has a corresponding temperature sensor, each temperature sensor may be accessed and addressed in a manner analogous to each strain sensor 202, 204, 212, 214, 222, 224, 232, 234, 242 and 244.

In operation, integrated sensor 200B receives control signal(s) via pads 270. The control signal identifies which of strain sensors 202, 204, 212, 214, 222, 224, 232, 234, 242 and 244 is to be selected for input and/or output. In some embodiments, this control signal is a digital signal. In response, addressing circuitry 260 connects the transmission and receive lines of lines 281 through 289 for the selected strain sensor 202, 204, 212, 214, 222, 224, 232, 234, 242 or 244 to the appropriate ones of pads 270 used for outputting information. Temperature may also be read for the selected strain sensor (e.g. from temperature sensor 250 and/or a temperature sensor corresponding to the selected strain sensors). This temperature data may be digital in some embodiments. A signal used in sensing strain is provided to the selected strain sensor via the connected transmission line(s). The signal may be an encoded signal, such as a pseudo-random binary sequence (PRBS) signal. The encoded signal for each strain sensor 202, 204, 212, 214, 222, 224, 232, 234, 242 and 244 may be unique. The selected strain sensor returns the strain data via its receive line. In some embodiments, the strain data is also an encoded (e.g. PRBS) signal. The strain data from each strain sensor 202, 204, 212, 214, 222, 224, 232, 234, 242 and 244 may also be a unique encoded signal. Thus, the information from each strain sensor 202, 204, 212, 214, 222, 224, 232, 234, 242 and 244 is distinguishable. In various embodiments, any appropriate technique that creates strain measurements that are distinguishable based upon the strain sensor providing the data may be used. This process of providing a control signal, connecting the appropriate transmission and receive lines for the selected strain sensor, receiving a signal and transmitting strain information can be repeated for the selected strain sensors 202, 204, 212, 214, 222, 224, 232, 234, 242 and/or 244. Thus, strain measurements from each of strain sensors 202, 204, 212, 214, 222, 224, 232, 234, 242 and 244 may be obtained in series.

For example, integrated sensor 200B receives a control signal at pads 271 and 272 that may be dedicated for transmission lines (i.e. receiving signals). The control signal indicates strain sensor 232 is to be selected for input and/or output. In response, addressing circuitry 260 connects transmission line 282 and receive line 281 for selected strain sensor 232 to pads 271 and 272 and pads 273 and 274, respectively. Temperature may also be read for the selected strain sensor (e.g. from temperature sensor 250). This temperature data may be provided via pads 271, 272, 273 and/or 274. An encoded voltage signal used in sensing strain is received at pads 271 and 272. The encoded voltage signal is provided to strain sensor 232 via transmission line 282. Strain data is read from strain sensor 232 and provided to pads 273 and 274 via receive line 281. Strain data from strain sensor 232 may thus be output from integrated sensor 200B. The control signal received at pads 271 and 272 may next select strain sensor 234 for input and/or output. Addressing circuitry 260 connects transmission line 287 to pads 271 and 272 and connects receive line 286 to pads 273 and 274. Another encoded voltage signal is received at pads 271 and 272 and provided to strain sensor 234 via transmission line 287. Strain data is read from strain sensor 234 and provided to pads 273 and 274 via receive line 286. Strain data from strain sensor 234 may be output from integrated sensor 200B. This process may continue to obtain data from remaining strain sensors 202, 204, 212, 214, 222, 224, 242 and 244.

Integrated sensors 200A and 200B may improve detection of physical disturbances. Temperature sensors, such as temperature sensor 250 provide an onboard measurement of the temperatures to which strain sensors 202, 204, 212, 214, 222, 224, 232, 234, 242 and 244 are exposed. Temperature sensor 200A may be used to account for drift and other temperature artifacts that may be present in strain data. Thus, the accuracy of measurements from strain sensors 202, 204, 212, 214, 222, 224, 232, 234, 242 and 244 may be enhanced. Addressing circuitry 260 in combination with line 281 through 289 that uniquely identify each strain sensor 202, 204, 212, 214, 222, 224, 232, 234, 242 and 244 may be used to select from which strain sensor data is received. Thus, a variety of strain measurements may be obtained. Because strain sensors 202, 204, 212, 214, 222, 224, 232, 234, 242 and 244 share lines 281 through 289 and pads 270, integrated sensors 200A and 200B are small in size. Thus, multiple independent measurements of strain may be obtained over confined area. Further, use of (110) silicon in strain sensors 202, 204, 212, 214, 222, 224, 232, 234, 242 and 244 may enhance sensitivity of strain sensors 202, 204, 212, 214, 222, 224, 232, 234, 242 and 244. Consequently, accuracy may be improved. Integrated sensors 200A and 200B may thus be more readily used in a device for detecting touch inputs.

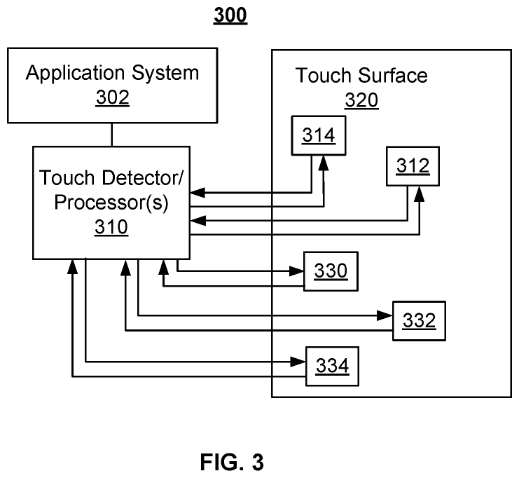

FIG. 3 is a block diagram illustrating an embodiment of system 300 for detecting a touch input. System 300 may be considered part of a device utilizing touch inputs. Thus, system 300 may be part of a kiosk, an ATM, a computing device, an entertainment device, a digital signage apparatus, a mobile phone, a tablet computer, a point of sale terminal, a food and restaurant apparatus, a gaming device, a casino game and application, a piece of furniture, a vehicle, an industrial application, a financial application, a medical device, an appliance, and any other objects or devices having surfaces for which a touch input is desired to be detected.

System 300 is connected with application system 302 and touch surface 320, which may be considered part of the device with which system 300 is used. System 300 includes touch detector 310, force sensors 312 and 314, transmitter 330 and touch sensors 332 and 334. For simplicity, only some portions of system 300 are shown. Touch surface 320 is a surface on which touch inputs are desired to be detected. For example touch surface may include the display of a mobile phone, the touch screen of a laptop, an edge of a mobile phone, a portion of the frame of the device or other surface. Force sensors 312 and 314 may be integrated sensors including multiple strain sensors, such as integrated sensor 200A and/or 200B. In other embodiments, force sensors 312 and 314 may be an individual strain sensor. Other force sensors may also be utilized. Although two force sensors 312 and 314 are shown, another number is typically present. Touch sensors 330 and 332 may be piezoelectric sensors. Transmitter 330 may also be a piezoelectric device. In some embodiments, touch sensors 330 and 332 and transmitter 330 are interchangeable. Touch sensors 330 and 332 may be considered receivers of an ultrasonic wave transmitted by transmitter 330. In other cases, touch sensor 332 may function as a transmitter, while transmitter 330 and touch sensor 334 function as receivers. Thus, a transmitter-receiver pair may be viewed as a touch sensor in some embodiments. Multiple receivers may share a transmitter in some embodiments. Although only one transmitter 330 is shown for simplicity, multiple transmitters may be used. Similarly, although two touch sensors 332 and 334 are shown, another number may be used. Application system 302 may include the operating system for the device in which system 300 is used.

In some embodiments, touch detector 310 is integrated in an integrated circuit chip. Touch detector 310 includes one or more microprocessors that process instructions and/or calculations that can be used to program software/firmware and/or process data for touch detector 310. In some embodiments, touch detector 310 include a memory coupled to the microprocessor and configured to provide the microprocessor with instructions. Other components such as digital signal processors may also be used.

Touch detector 310 may provide the control signal for addressing individual strain sensors within force sensors 312 and 314 (e.g. integrated sensor 200B). Thus, touch detector 310 may provide the control signal to addressing circuitry (e.g. addressing circuitry 260). Touch detector 310 also receives input from force sensors 312 and 314, touch sensors 332 and 334 and, in some embodiments, transmitter 330. For example, touch detector 310 receives force (e.g. strain) measurements from force sensors 312 and 314. Touch detector 310 also receives touch (e.g. piezoelectric voltage) measurements from touch sensors 332 and 334. Touch detector 310 may provide signals and/or power to force sensors 312 and 314, touch sensors 332 and 334 and transmitter 330. For example, touch detector 310 may provide the input voltage(s) to force sensors 312 and 314, voltage or current to touch sensor(s) 332 and 334 and a signal to transmitter 330. Touch detector 310 utilizes the force (strain) measurements and/or touch (piezoelectric) measurements to determine whether a user has provided touch input touch surface 320. If a touch input is detected, touch detector 310 provides this information to application system 302 for use.

Signals provided from force sensors 312 and 314 are received by touch detector 310 and may be conditioned for further processing. For example, touch detector 310 receives encoded strain measurements from each strain sensor in force sensors 312 and 314. Although described in the context of encoded signals, any appropriate technique that creates strain measurements that are distinguishable based upon the strain sensor providing the data may be used. Touch detector 310 determines from which strain sensor each encoded strain measurement arises. This may be accomplished by determining the specific encoding used for the strain sensor. Touch detector 310 may also decode the signals to obtain decoded strain measurements. Touch detector 310 may utilize the strain measurements to track the baseline signals (e.g. voltage, strain, or force) for the strain sensors within force sensors 312 and 314. Strains due to temperature may also be accounted for by touch detector 310 using signals from temperature sensor(s), such as temperature sensor 250. Touch detector 310 may obtain absolute forces (the actual force on touch surface 320) from force sensors 312 and 314 by accounting for temperature. In some embodiments, a model of strain versus temperature for force sensors 312 and 314 is used. In some embodiments, a model of voltage or absolute force versus temperature may be utilized to correct force measurements from force sensors 312 and 314 for temperature.

In some embodiments, touch sensors 332 and 334 sense touch via a wave propagated through touch surface 320, such as an ultrasonic wave. For example, transmitter 330 outputs such an ultrasonic wave. Touch sensors 332 and 334 function as receivers of the ultrasonic wave. In the case of a touch by a user, the ultrasonic wave is attenuated by the presence of the user's finger (or other portion of the user contacting touch surface 320). This attenuation is sensed by one or more of touch sensors 332 and 334, which provide the signal to touch detector 310. The attenuated signal can be compared to a reference signal. A sufficient difference between the attenuated signal and the reference signal results in a touch being detected. In some embodiments, absolute forces may be obtained from the imputed force measurements.

As discussed above for integrated sensors 200A and 200B, encoded signals may be used in system 300. Thus, touch detector 310 may also provide encoded signals for touch measurements. In some embodiments, transmitter 330 provides an encoded signal for touch sensors 332 and/or 334. For example, transmitter 330 may use a first PRBS to transmit a signal. If multiple transmitters are used, the encoded signals may differ to be able to discriminate between signals. For example, the first transmitter may use a first PRBS and the second transmitter may use a second, different PRBS which creates orthogonality between the transmitters and/or transmitted signals. Such orthogonality permits a processor or sensor coupled to the receiver to filter for or otherwise isolate a desired signal from a desired transmitter. In some embodiments, the different transmitters use time-shifted versions of the same PRBS. In some embodiments, the transmitters use orthogonal codes to create orthogonality between the transmitted signals (e.g., in addition to or as an alternative to creating orthogonality using a PRBS). In various embodiments, any appropriate technique to create orthogonality may be used.

Thus, using the combination of force sensors 312 and 314 and touch sensors 332 and 334, touches may be detected. Further, based upon which sensor 312, 314, 332 and/or 334 detects the touch and/or characteristics of the measurement (e.g. the magnitude of the force detected), the location of the touch in addition to the presence of a touch may be identified. For example, given an array of force and/or touch sensors, a location of a touch input may be triangulated based on the detected force and imputed force measurement magnitudes and the relative locations of the sensors that detected the various magnitudes (e.g., using a matched filter). Further, data from force sensors 312 and 314 is utilized in combination with data from touch sensors 332 and 334 to detect touches. Utilization of a combination of force and touch sensors allows for the detection of touch inputs while accounting for variations in temperature, bending, user conditions (e.g. the presence of a glove) and/or other factors. Thus, detection of touches using system 300 may be improved.

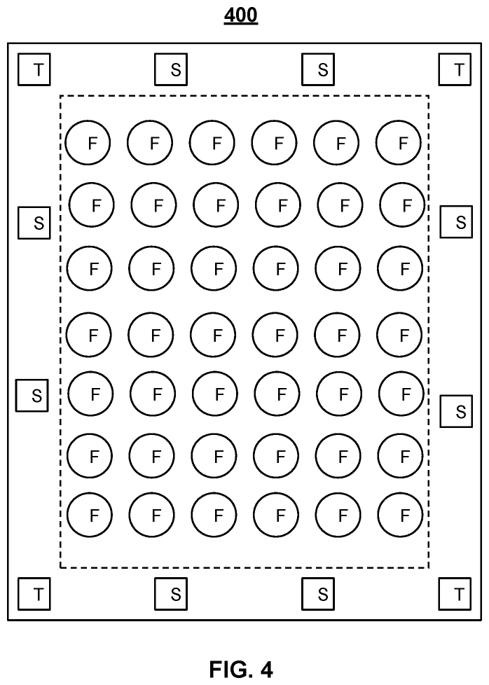

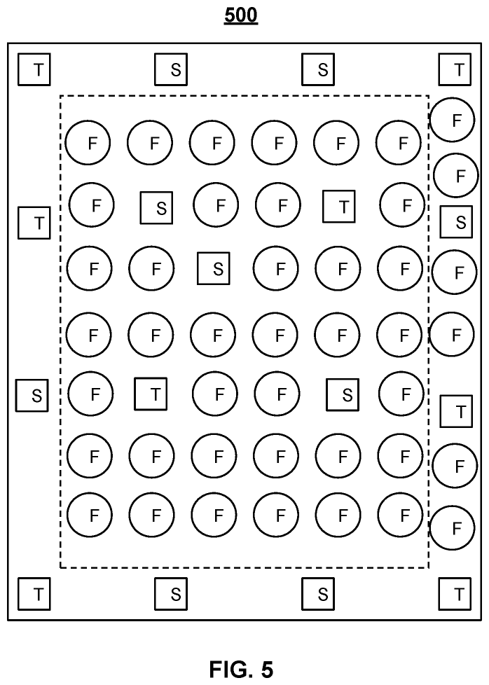

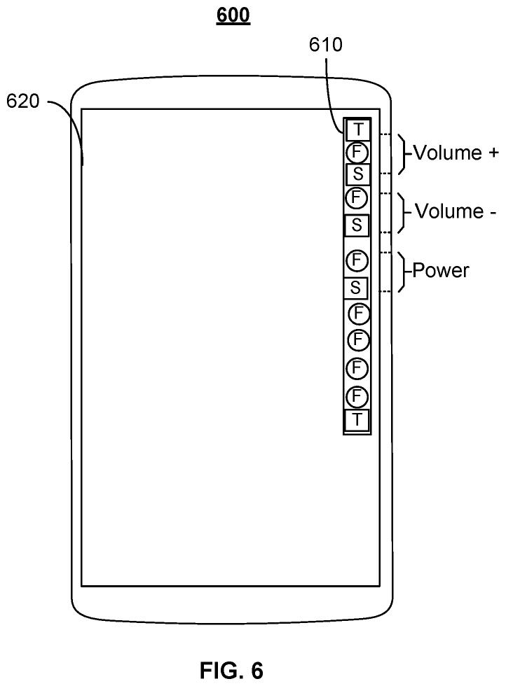

FIGS. 4-6 depict different embodiments of systems 400, 500, and 600 utilizing force and touch sensors for touch input detection. Force sensors, such as sensor(s) 100, 200A, 200B, 312 and/or 314, are denoted by an “F”. Such force sensors are shown as circles and may be considered to be piezoresistive (e.g. strain) sensors. Touch sensors such as sensor(s) 332 and/or 334 are shown by an “S”. Transmitters, such as transmitter 330, are shown by a “T”. Such sensors and transmitters may be piezoelectric sensors and are shown as rectangles. As indicated above, sensor component arrangements are utilized to detect a touch input along a touch surface area (e.g., to detect touch input on a touchscreen display, a portion of a mobile phone, or other region of a device desired to be sensitive to touch). The number and arrangement of force sensors, transmitters, and touch sensors shown in FIGS. 4-6 are merely examples and any number, any type and/or any arrangement of transmitters, force sensors and touch sensors may exist in various embodiments.

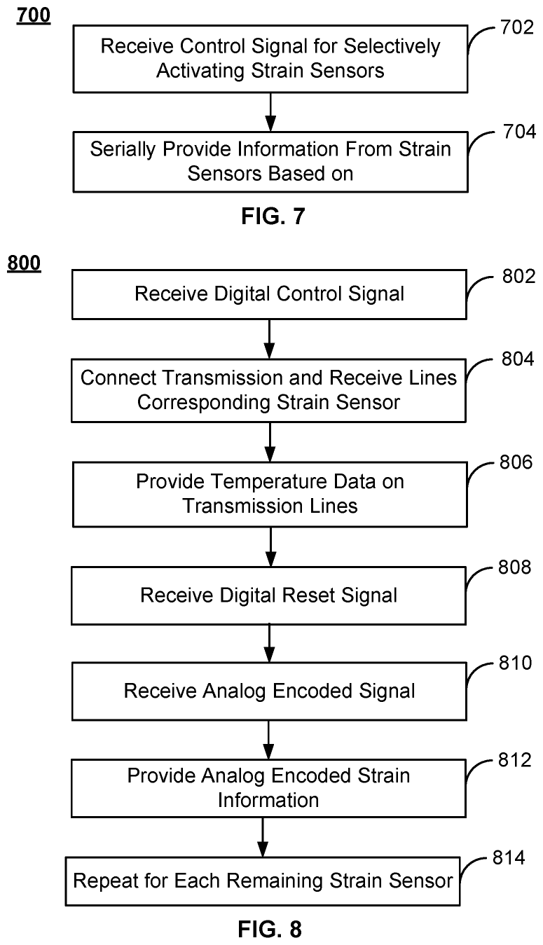

FIG. 7 is a flow chart depicting an embodiment of method 700 for sensing force utilizing integrated sensors. In some embodiments, processes of method 700 may be performed in a different order, including in parallel, may be omitted and/or may include substeps.

A control signal is received, at 702. In some embodiments, the control signal is received on lines corresponding to transmission lines. Thus, lines which are used to transmit signals to the strain sensors may also be used to provide the control signal. The control signal is used to selectively activate the strain sensors to provide information on the corresponding receive lines. The control signal indicates the selected strain sensor by identifying particular transmission line(s) and receive line(s). Because the strain sensors are identified by transmission line-receive line combinations, the control signal may be used to address the strain sensors.

In response to the control signal, the strain sensors serially provide information using the common receive line(s), at 704. In some embodiments, this is accomplished by connecting the transmission and receive lines of the selected strain sensor to the appropriate pads for input to/output from the integrated sensor. Thus, a particular strain sensor is connected to lines over which information may be output. In some embodiments, other information, such as temperature, may also be output. Once the strain sensor has provided its data, transmission and receive lines for another strain sensor identified by the control signal may be connected for input/output. This process continues to serially provide information from the strain sensors. Thus, using method 700, information may be provided by multiple strain sensors.

For example, method 700 may be utilized in connection with integrated sensor 200B. At 702, a control signal is received at integrated sensor 200B. The control signal may be received at one or more of pads 270. The control signal is provided to addressing circuitry 260. In response, addressing circuitry connects a particular combination of transmission and receive lines to pads 270. For example, the control signal received at 702 may first identify strain sensor 232 (i.e. lines 281 and 282). Thus, transmission line 282 and receive line 281 are connected by addressing circuitry 260 to some portion of pads 270. Thus, strain sensor 232 is selected. Strain sensor 232 provides information via receive lines 281, at 704. For example, an encoded signal may be provided to strain sensor 232 via transmission line 282. Strain sensor 232 provides strain information via receive line 281. In some embodiments, temperature information is also provided.

The control signal received at 702 may next identify strain sensor 204 (i.e. lines 281 and 284). Thus, addressing circuitry 260 connects transmission line 284 and receive line 281 to some portion of pads 270. Thus, strain sensor 204 is selected. Strain sensor 204 provides information via receive lines 281, at 704. For example, an encoded signal may be provided to strain sensor 204 via transmission line 284. Strain sensor 204 provides strain information via receive line 281. In some embodiments, temperature information is also provided. This process may continue to allow some or all of strain sensors 232, 204, 242, 202, 212, 214, 222, 244, 224 and 234 to output information, in series, via the appropriate receive lines. Thus, method 700 may be used to provide information from integrated sensor 200B.

Using method 700 strain information may be provided from sensors on an integrated sensor. Method 700 allows for strain sensors to be individually addressed, share pads and share common receive and/or transmission lines. As a result, accurate information may be provided by an integrated sensor that is compact. Further, because fewer pads are used, the pads may be made larger. Thus, connection to the strain sensor may be facilitated.

FIG. 8 is a flow chart depicting an embodiment of method 800 for sensing force utilizing integrated sensors, such as sensor 200B. In some embodiments, processes of method 800 may be performed in a different order, including in parallel, may be omitted and/or may include substeps.

A digital control signal is received, at 802. In some embodiments, the digital control signal includes a digital signal and a clock signal received over lines corresponding to transmission line(s) for a strain sensor. The digital control signal identifies the strain sensor from which data is desired to be obtained. In some embodiments, the strain sensor is uniquely identified by the combination of transmission and receive lines coupled to the strain sensor.

In response to the digital control signal, the identified strain sensor is coupled to output lines, at 804. The output lines couple the strain sensor to other components. For example, the output lines may connect the integrated sensor to a touch detector or other processor. In some embodiments, 804 includes connecting the receive lines identified by the digital control signal to the pads of the integrated sensor used in outputting information. The transmission lines for the strain sensor are also connected to the pads used in receiving signals. Thus, the strain sensor identified by the digital control signal may receive input signals and output information. Temperature data for the strain sensor is provided, at 806. In some embodiments, a single temperature sensor provides temperature data for all strain sensors being used. In some embodiments, each strain sensor has a corresponding temperature sensor that can provide temperature data. Temperature data may be provided on the transmission lines used to transmit the control signal to the integrated sensor. A digital reset signal is received, at 808. In some embodiments, the reset signal includes grounding the corresponding transmission lines. Thus, the integrated sensor may transition into an analog mode.

An analog encoded signal is received, at 810. At 810, the encoded signal is received at the strain sensor identified by the digital control signal. For example, a PRBS voltage signal might be generated, sent to the integrated sensor, and received at the addressed strain sensor, at 810. In response, the selected strain sensor outputs information, at 812. In some embodiments, the information output at 812 is in the form of an analog encoded signal corresponding to the input signal received. For example, if the voltage input to a strain sensor (e.g. a Wheatstone bridge) at 810 was encoded in a particular manner, the strain information output may also have this encoded format. At 814, method 800 may be repeated to obtain strain information from each of the sensor in series.

For example, method 800 may be utilized in connection with integrated sensor 200B. At 802, a digital control signal provided by touch detector 310 is received at integrated sensor 200B. In some embodiments, the digital control signal is received at pads 271 and 272. Suppose the digital control signal first identifies strain sensor 232 (i.e. lines 281 and 282) for providing strain data. In response to the control signal, addressing circuitry 260 connects transmission line 282 is connected to pads 271 and 272 and connects receive line 281 to pads 273 and 274, at 804. Thus, strain sensor 232 is selected. Temperature data corresponding to strain sensor 232 may be provided at 806. In some embodiments, temperature data may be provided from temperature sensor 250 for all strain sensors at the start of method 800. The temperature data may be provided to touch detector 310 via the lines which transmit the control signal (e.g. output via pad(s) 271 and/or 272). A digital reset signal is received by integrated sensor 200B via pads 271 and 272, at 808. Thus, integrated sensor 200B transitions to an analog mode. In some embodiments, the digital reset signal includes grounding the selected transmission line(s) 282.

An analog encoded signal is received at pads 271 and 272, at 810. In the example above, the encoded voltage signal might be generated by touch detector 310 and sent to integrated sensor 200B. Because transmission line 282 is connected to pads 271 and 272, the analog encoded signal is also received at strain sensor 232. In some embodiments, the encoded signal is unique for each strain sensor. The strain information is provided by selected strain sensor 232 on receive line 281, at 812. This strain information is encoded in a manner corresponding to the analog encoded signal received at strain sensor 232. Thus, the strain information provided by selected strain sensor 232 can be distinguished from strain information from other strain sensors.

At 814, method 800 may be repeated to obtain strain information from each of the sensor in series. For example, at 802, the digital control signal may specify that the next sensor to be used is sensor 204. In response to the control signal, addressing circuitry 260 connects transmission line 284 to pads 271 and 272 and connects receive line 281 to pads 273 and 274. Temperature data corresponding to strain sensor 204 may be provided at 806. In other embodiments, temperature data may be separately provided from temperature sensor 250, for example only at the start of method 800. A digital reset signal is received by integrated sensor 200B via pads 271 and 272, at 808. Thus, integrated sensor 200B transitions to an analog mode. In some embodiments, the digital reset signal includes grounding the selected transmission line(s) 284.

An analog encoded signal is received at pads 271 and 272, at 810. In the example above, the encoded voltage signal might be generated by touch detector 310 and sent to integrated sensor 200B. Because transmission line 284 is connected to pads 271 and 272, the analog encoded signal is also received at strain sensor 204. In some embodiments, the encoded signal is unique for each strain sensor. The strain information is provided by selected strain sensor 204 on receive line 281, at 812. This strain information is also encoded in a manner analogous to the analog encoded signal received by strain sensor 204. Thus, the strain information provided by selected strain sensor 204 can be distinguished from strain information from other strain sensors. This process may be continued for remaining strain sensors 242, 202, 212, 214, 222, 244, 224 and 234.

Using method 800 strain information may be provided from sensors on an integrated sensor. Method 800 allows for strain sensors to be individually addressed, share pads and share common receive and/or transmission lines. In some embodiments, the strain sensors used also have enhanced sensitivity. As a result, accurate information may be provided by an integrated sensor that is compact. Further, because fewer pads are used, the pads may be made larger. Thus, connection to the strain sensor may be facilitated.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a plurality of strain sensors;
a plurality of transmission lines on which each strain sensor can receive a signal; and
a common receive line on which information from the plurality of strain sensors is provided;
wherein the plurality of strain sensors are configured to be selectively activated to transmit information on the common receive line in response to a control signal.

2. The system of claim 1, further comprising:
addressing circuitry for selectively activating each of the plurality of strain sensors in response to the control signal.

3. The system of claim 1, wherein the plurality of strain sensors reside on a single integrated circuit.

4. The system of claim 3, wherein the plurality of strain sensors and the addressing circuitry reside on a single integrated circuit, the system further including:
a plurality of pads residing on the integrated circuit and having a number insufficient for operating multiple strain sensor.

5. The system of claim 1, wherein the plurality of strain sensors are formed on a silicon substrate having a (110) orientation.

6. The system of claim 1, wherein a first portion of the plurality of strain sensors have a first orientation and a second portion of the plurality of strain sensors has a second orientation at a nonzero acute angle from the first orientation.

7. The system of claim 1, further comprising:
at least one temperature sensor corresponding to the plurality of strain sensors.

8. The system of claim 1, wherein the information includes temperature information and strain information.

9. A system, comprising:
a plurality of strain sensors;
a plurality of transmission lines on which a signal can be transmitted to each strain sensor of the plurality of strain sensors, each of the plurality of transmission lines being shared by a first portion of the plurality of strain sensors;
a plurality of receive lines on which information can be received from each strain sensor of the plurality of strain sensors, each of the plurality of receive lines being shared by a second portion of the plurality of strain sensors; and
addressing circuitry configured to selectively activate each of the plurality of strain sensors to transmit information on a corresponding common receive line in response to receiving a control signal.

10. The system of claim 9, wherein the plurality of strain sensors and the addressing circuitry reside on an integrated circuit, the system further including:
a plurality of pads residing on the integrated circuit and having a number insufficient for operating multiple strain sensor.

11. The system of claim 10, wherein the integrated circuit includes a silicon substrate having a (110) orientation.

12. The system of claim 9, wherein a third portion of the plurality of strain sensors has a first orientation and a fourth portion of the plurality of strain sensors has a second orientation at a nonzero acute angle from the first orientation.

13. The system of claim 9, further comprising:
at least one temperature sensor corresponding to the plurality of strain sensors.

14. The system of claim 9, wherein the information includes temperature information and strain information.

15. A method, comprising:
receiving a control signal at an integrated circuit including a plurality of strain sensors, a plurality of transmission lines for transmitting signals to the plurality of strain sensors, and a plurality of receive lines for providing information from the plurality of strain sensors, the control signal for selectively activating the plurality of strain sensors to provide information on the plurality of receive lines; and
serially providing the information from the plurality of strain sensors on the plurality of receive lines.

16. The method of claim 15, wherein the control signal is a digital control signal indicating a transmission line of the plurality of transmission lines and a receive line of the plurality of receive lines, and wherein the method further includes:
connecting a strain sensor of the plurality of strain sensors to an output line, the strain sensor corresponding to the transmission line and the receive line in response to the digital control signal; and
providing digital information from the strain sensor.

17. The method of claim 16, wherein the digital information includes temperature data.

18. The method of claim 16, further comprising:
receiving a digital reset after the providing digital information;
receiving at the strain sensor an encoded analog signal corresponding to the information; and
providing from the strain sensor the information based on the encoded analog signal.

19. The method of claim 18, further comprising:
repeating the connecting, digital information providing, digital reset receiving, encoded analog signal receiving and information providing for each remaining strain sensor of the plurality of strain sensors.

20. The method of claim 15, wherein a first portion of the plurality of strain sensors have a first orientation and a second portion of the plurality of strain sensors has a second orientation at a nonzero acute angle from the first orientation.
